(19) United States
(12) Patent Application Publication
(10) Pub. No.: US 2022/0374889 A1
(43) Pub. Date: Nov. 24, 2022

(54) VIRTUAL PAYMENT METHOD AND SYSTEM

(71) Applicant: TravelSky Technology Limited, Beijing (CN)

(72) Inventors: Zhidan Zhang, Beijing (CN); Sujuan Zhang, Beijing (CN); Ying Xin, Beijing (CN); Yanna Li, Beijing (CN); Xue Li, Beijing (CN); Xiaoliang Wang, Beijing (CN); Xiaofeng Fei, Beijing (CN); Yongwang Zhang, Beijing (CN); Zhonglin Jiang, Beijing (CN); Xinhui Song, Beijing (CN)

(73) Assignee: TravelSky Technology Limited, Beijing (CN)

(21) Appl. No.: 17/641,795

(22) PCT Filed: Nov. 3, 2020
(86) PCT No.: PCT/CN2020/126074

§ 371 Date: Mar. 9, 2022

(30) Foreign Application Priority Data
Nov. 22, 2019 (CN) 201911154491.4

(51) Int. Cl. G06Q 20/40; G06Q 10/02

(52) U.S. Cl. CPC G06Q 20/40; G06Q 10/02

(57) ABSTRACT

A virtual payment method and system. A first virtual account is associated with a physical account, and a second virtual account is associated with the physical account. That is, virtual accounts of different accounts are all associated with the physical account. During the payment for flight ticket booking information by means of virtual payment, it is an exchange of a virtual currency between different virtual accounts associated with the same physical account. During the process, balances in virtual accounts that exchange virtual currencies with each other change, but the total amount in the physical account associated with a plurality of different virtual accounts remains unchanged, that is, the actual currency amount in the physical account does not change. The present invention would not he restricted by an implementation measure of the Central Bank. In the present invention, a third-party trading platform is not used, payment of a consumption amount is directly achieved by means of a plurality of virtual accounts under a physical account within own platform thereof, and a balance exchange between different virtual accounts is performed under the same account, without a daily or annual transaction limit.

The present application claims priority to Chinese Patent Application No. 201911154491.4, titled “VIRTUAL PAYMENT METHOD AND SYSTEM”, filed on Nov. 22, 2019 with the China National intellectual Property Administration, which is incorporated herein by reference in its entirety.

### FIELD

The present disclosure relates to the field of control technology, and in particular to a virtual payment method and system.

### BACKGROUND

A B2B (business-to-business) website of an airline is a channel for the airline selling flight tickets to ticket agents. The agents query and book flight tickets and pay on the website. At present, third-party payment based on physical currency, such as payment through a payment window or through a cross ticket platform, accounts for a large proportion of online payment on the airline B2B website.

At present, annual payment amount of B2B websites of all airlines is about 100 billion. However, since Jul. 1, 2016, the people's Bank of China has implemented measures for the administration of online payment business of non-bank payment institutions, which restricts the payment of accounts of third-party payment platforms. For example, there is a limit management for transactions paid by individual customers using payment accounts. A daily cumulative transaction limit is 1000 yuan or 5000 yuan, and an annual cumulative transaction limit is 100000 yuan or 200000 yuan. As a result, when a user trades on the B2B websites of airlines through the third-party platforms, the transaction cannot proceed smoothly due to the transaction limit.

### SUMMARY

In view of this, a virtual payment method and system are provided according to the present disclosure. The technical solutions are as following.

A virtual payment method includes:

acquiring flight ticket reservation information;

determining an account for sending the flight ticket reservation information based on the flight ticket reservation information, and determining that a payment mode for the flight ticket reservation information is virtual payment;

determining a virtual account of the account and setting the virtual account of the account as a first virtual account, wherein the first virtual account is associated with a physical account;

acquiring a virtual payment password of the first virtual account for the virtual payment:

deducting a virtual currency with an amount equal to amount of consumption in the flight ticket reservation information from a balance of virtual currency in the first virtual account, according to the virtual payment; and

adding the virtual currency with the amount equal to the amount of consumption in the flight ticket reservation information to a virtual account of an airline in the flight ticket reservation information, where the virtual account of the airline in the flight ticket reservation information is set as a second virtual account and the second virtual account is associated with the physical account.

In an embodiment, the determining an account for sending the flight ticket reservation information based on the flight ticket reservation information, and determining that a payment mode for the flight ticket reservation information is virtual payment includes:

determining the account for sending the flight ticket reservation information based on the flight ticket reservation information; and

verifying validity of the account, and determining that the payment mode for the flight ticket reservation information is virtual payment in a case that the account is valid.

In an embodiment, the method further includes: querying the balance of the virtual currency in the first virtual account to determine the balance of the virtual currency in the first virtual account.

In an embodiment, the deducting a virtual currency with an amount equal to amount of consumption in the flight ticket reservation information from a balance of virtual currency in the first virtual account according to the virtual payment includes:

determining the amount of consumption in the flight ticket reservation information; and

deducting the virtual currency with the amount equal to the amount of consumption in the flight ticket reservation information from the balance of the virtual currency in the first virtual account, in a case that the balance of the virtual currency in the first virtual account is greater than the amount of consumption in the flight ticket reservation information.

In an embodiment, the method further includes:

applying for a physical account; and

registering multiple virtual accounts based on the applied physical account, where the multiple virtual accounts belong to different accounts respectively, and the virtual accounts for different accounts are associated with the physical account.

A virtual payment system includes: a reservation information acquisition unit, a first determination unit, a virtual account determination unit, a password acquisition unit, a deduction unit, and an addition unit.

The reservation information acquisition unit is configured to acquire flight ticket reservation information.

The first determination unit is configured to determine an account for sending the flight ticket reservation information based on the flight ticket reservation information, and determine that a payment mode for the flight ticket reservation information is virtual payment.

The virtual account determination unit is configured to determine a virtual account of the account and set the virtual account of the account as a first virtual account, wherein the first virtual account is associated with a physical account.

The password acquisition unit is configured to acquire a virtual payment password of the first virtual account for virtual payment.

The deduction unit is configured to deduct a virtual currency with an amount equal to amount of consumption in the flight ticket reservation information from a balance of virtual currency in the first virtual account, according to the virtual payment.

The addition unit is configured to add the virtual currency with the amount equal to the amount of consumption in the flight ticket reservation information to a virtual account of an airline in the flight ticket reservation information, where the virtual account of the airline in the flight ticket reservation information is set as a second virtual account and the second virtual account is associated with the physical account.

In an embodiment, the first determination unit is configured to: determine the account for sending the flight ticket reservation information based on the flight ticket reservation information; and verify validity of the account and determine that the payment mode for the flight ticket reservation information is virtual payment in a case that the user account is valid.

In an embodiment, the system further includes: a query unit configured to query the balance of the virtual currency in the first virtual account to determine the balance of the virtual currency in the first virtual account.

In an embodiment, the deduction unit is configured to: determine the amount of consumption in the flight ticket reservation information; and deduct the virtual currency with the amount equal to the amount of consumption in the flight ticket reservation information from the balance of the virtual currency in the first virtual account, in a case that the balance of the virtual currency in the first virtual account is greater than the amount of consumption in the flight ticket reservation information.

In an embodiment, the system further includes: an application unit configured to apply for a physical account; and register multiple virtual accounts based on the applied physical account, where the multiple virtual accounts belong to different accounts respectively, and the virtual accounts for different accounts are associated with the physical account.

In the above technical solutions, with the virtual payment method and system according to the present disclosure, flight ticket reservation information is acquired, and an account for sending the flight ticket reservation information is determined based on the flight ticket reservation information. It is determined that a payment mode for the flight ticket reservation information is virtual payment, and a virtual account for the account is determined. The virtual account for the account is set as a first virtual account, and the first virtual account is associated with a physical account. A virtual payment password of the first virtual account is acquired to perform virtual payment. A virtual currency with an amount equal to the amount of consumption in the flight ticket reservation information is deducted from the balance of the virtual currency in the first virtual account according to the virtual payment. The virtual currency with the amount equal to the amount of consumption in the flight ticket reservation information is added to a virtual account for the airline in the flight ticket reservation information. The virtual account for the airline in the flight ticket reservation information is set as a second virtual account, and the second virtual account is associated with the physical account. In the present disclosure, the first virtual account is associated with the physical account, and the second virtual account is associated with the physical account. That is, the virtual accounts for different accounts are associated with the physical account. The payment for the flight ticket reservation information through the virtual payment is actually an exchange of virtual currency between different virtual accounts associated with the same physical account, In this process, balances in the virtual accounts exchanging virtual currency with each other change, while a total amount of the physical account associated with the different virtual accounts remains unchanged. That is, an actual monetary amount in the physical account does not change, so that the payment is not limited by the implementation measures of the people's bank of China. The third-party trading platform is not required. The payment for consumption amount is directly realized through multiple virtual accounts under one physical account in a platform of the airline. The balances of different virtual accounts under the same physical account are changed without a daily transaction limit and an annual transaction limit.

### BRIEF DESCRIPTION OF THE DRAWINGS

In order to clearly describe the technical solutions in the embodiments of the present disclosure or the technical solutions in the conventional technology, drawings to be used in the description of the embodiments of the present disclosure or the conventional technology are briefly described hereinafter. It is apparent that the drawings described below are merely used for describing the embodiments of the present disclosure, and those skilled in the art may obtain other drawings according to the provided drawings without any creative effort.

FIG. 1 is a flowchart of a virtual payment method according to an embodiment of the present disclosure;

FIG. 2 is a schematic diagram showing a correspondence between a physical account and a virtual account according to an embodiment of the present disclosure;

FIG. 3 is a flowchart of a virtual payment method according to an embodiment of the present disclosure;

FIG. 4 is a schematic structural diagram of a virtual payment device according to an embodiment of the present disclosure; and

FIG. 5 is a schematic structural diagram of a virtual payment system according to an embodiment of the present disclosure.

### DETAILED DESCRIPTION OF EMBODIMENTS

Technical solutions of the embodiments of the present disclosure are described below in conjunction with the drawings of the embodiments of the present disclosure. Apparently, the embodiments described below are only some embodiments of the present disclosure, rather than all the embodiments. Any other embodiments obtained by those skilled in the art based on the embodiments in the present disclosure without any creative effort fall within the protection scope of the present disclosure.

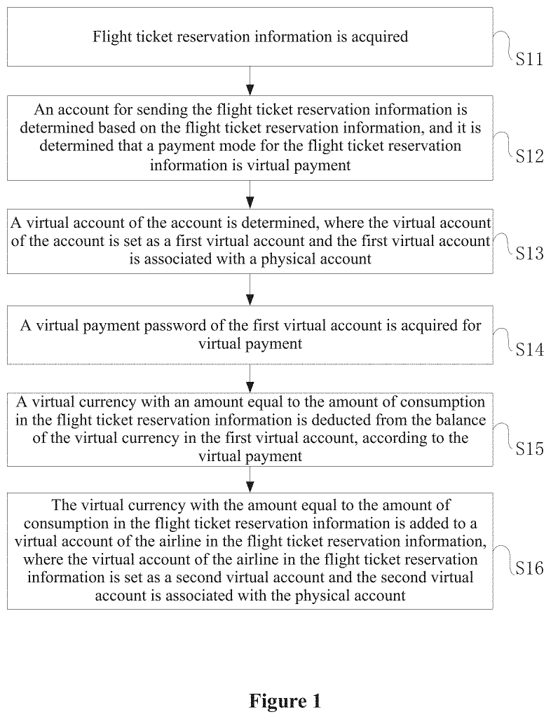

A virtual payment method is provided according to the present disclosure. A flowchart of the virtual payment method is as shown in FIG. 1. The method includes the following steps S11 to S16.

In step S11, flight ticket reservation information is acquired.

In step S12, an account for sending the flight ticket reservation information is determined based on the flight ticket reservation information, and it is determined that a payment mode for the flight ticket reservation information is virtual payment.

In step S13, a virtual account of the account is determined, where the virtual account of the account is set as a first virtual account and the first virtual account is associated with a physical account.

A user logs in to an account of an airline website, and then determines the flight ticket reservation information on the website, so that a virtual payment system can receive the flight ticket reservation information determined by the user. The flight ticket reservation information includes relevant information on a reserved flight ticket, the consumption amount, an account reserving the flight ticket, time for reserving the flight ticket and the like.

After determining the account sending the flight ticket reservation information, the virtual payment system is required to determine a payment mode for the flight ticket reservation information. The virtual payment system sends inquiry information for the payment mode. That is, the virtual payment system sends the inquiry information to the account of the user to inquire which payment mode is used by the account of the user for virtual payment.

The payment mode includes internet banking payment, payment through a third-party payment platform, and virtual payment.

The user feeds back the payment mode through the account. If the user feeds back the virtual payment, the virtual payment system determines that the payment mode is the virtual payment.

After the account of the user is determined, it is required to further determine a virtual account corresponding to the account of the user. Generally, each account corresponds to one virtual account. However, in some cases, one account corresponds to multiple virtual accounts.

For ease of expression, the virtual account corresponding to the account is set as the first virtual account, and the first virtual account is associated with a physical account.

The physical account is a real bank account, for example, an account having an account number 6228 8888 8888 8888 in Bank of China or an account having an account number 6228 4888 8888 8888 888 in Agricultural Bank of China.

The virtual account is under a physical account and belongs the physical account. The virtual account is a sub account having an account number with a suffix at the bank level, that is, the virtual account is a sub account of the physical account. For example, a physical account in a bank has an account number 1234567890. A first virtual account may have an account number 1234567890-0001, and a second virtual account may have an account number 1234567890-0002.

A physical account may include multiple virtual accounts, that is, multiple sub accounts. Different virtual accounts may belong to different user accounts. For example, a first virtual account belongs to a first user account, a second virtual account belongs to a second user account, and an nth virtual account belongs to an account of an airline.

Since a physical account includes multiple virtual accounts, each virtual account usually has a certain amount of virtual currency. If a user desires to perform virtual transaction, the user is required to register a virtual account under the physical account. After registering the virtual account, the user may recharge the virtual account through a mobile terminal or in an offline mode, so that there is virtual currency in the virtual account. After the virtual account is recharged, virtual currency with the same amount as the recharged virtual currency is added to the physical account. Alternatively, when virtual payment is required, the virtual account is recharged through a mobile terminal or in offline mode, to make the virtual account have virtual currency, such that the virtual payment can be performed.

For example, the first virtual account is recharged with 1000 yuan. Since the first virtual account is associated with the physical account, the physical account associated with the first virtual account is also recharged with 1000 yuan.

Since there are multiple virtual accounts under one physical account and the multiple virtual accounts belong to different user accounts, recharging the first virtual account does not have any effect on other virtual accounts and the physical account adds the recharged amount. In addition, recharging other virtual accounts does not have any effect on the first virtual account, and the physical account adds the recharged amount.

The physical account in this embodiment may be a physical account of an airline. The virtual account associated with the physical account may be a virtual account for a user account that have transacted with the airline, or a virtual account for a user who will transact with the airline. Multiple virtual accounts under one physical account may belong to different user accounts. Apparently, the multiple virtual accounts associated with the physical account is required to include at least one virtual account belong to the airline which is used to perform virtual currency transactions with the virtual accounts for other user accounts under the physical account.

Further, if other payment mode, rather than the virtual payment, is used, for example, if payment is performed on a third-party payment platform such as Alipay, the solution disclosed in this embodiment is not applied and an original payment mode is used. However, there is a payment limit in the original payment mode. In addition, the third-party payment platform may earn handling fees.

In step S14, a virtual payment password of the first virtual account is acquired for virtual payment.

When the payment is determined to he performed in the virtual payment mode, the virtual payment system sends an interface to a terminal in which the user account is logged in. This interface is used for the user to enter the payment password. After the user enters the payment password, the virtual payment system acquires the payment password and verifies validity of the payment password. If the payment password is valid, the following steps for virtual payment are performed. If the payment password is invalid, a prompt window which displays that the payment password is wrong is sent to the terminal with the user account.

In step S15, a virtual currency with an amount equal to the amount of consumption in the flight ticket reservation information is deducted from the balance of the virtual currency in the first virtual account, according to the virtual payment.

In step S16, the virtual currency with the amount equal to the amount of consumption in the flight ticket reservation information is added to a virtual account of the airline in the flight ticket reservation information. The virtual account of the airline in the flight ticket reservation information is set as a second virtual account and the second virtual account is associated with the physical account.

After it is determined that the payment password is valid, the virtual payment is continued. In the process of virtual payment, the virtual currency with the amount equal to the amount of consumption in the flight ticket reservation information is deducted from the balance of the virtual currency in the virtual account corresponding to the account. In addition, the virtual currency with the amount equal to the amount of consumption is added to the virtual account for the airline in the flight ticket reservation information.

That is, the amount of consumption in the flight ticket reservation information is determined first. Then, the virtual account for the airline in the flight ticket reservation information, that is, the second virtual account, is determined. A virtual currency with an amount equal to the amount of consumption is transferred from the first virtual account to the second virtual account. In other words, the virtual currency with the amount equal to the amount of consumption is deducted from the first virtual account, and the virtual currency with the amount equal to the amount of consumption is added to the second virtual account. In this way, the virtual payment is completed.

In the above process of virtual payment, both the first virtual account and the second virtual account are associated with the same physical account, which are sub accounts of the physical account. In the transfer process of virtual currency from the first sub account to the second sub account, the total amount of the physical account is not changed. Therefore, the amount of a real bank account is not changed. A part of the amount of the real account is transferred from a sub account to another sub account, which is account management inside the real account and does not increase or decrease the amount of the real account. Therefore, the transfer of virtual currency between sub accounts in the real account is not limited by the amount of bank transfer.

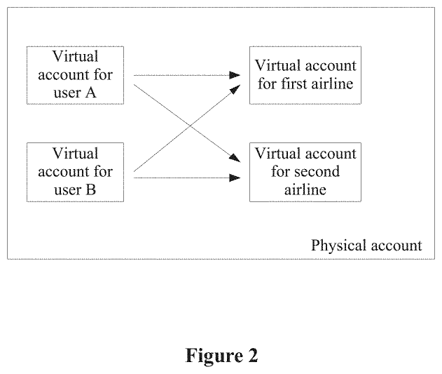

FIG. 2 shows a physical account in a bank. As shown in FIG. 2, the physical account has an account number 1234567890. Virtual accounts associated with the physical account include: a virtual account having an account number 1234567890-0001 for a user A, a virtual account having an account number 1234567890-0002 for a user B, a virtual account having an account number 1234567890-0011 for a first airline, and a virtual account having an account number 1234567890-0012 for a second airline. The above four virtual accounts are associated with the physical account and are sub accounts of the physical account.

When the user A purchases a flight of the first airline, the user A transfers a virtual currency with the amount of consumption corresponding to the flight from the virtual account for the user A to the virtual account for the first airline. When the user B purchases a flight of the first airline, the user B transfers a virtual currency with the amount of consumption corresponding to the flight from the virtual account for the user B to the virtual account for the first airline. In another embodiment, the user A and the user B may purchase a flight of the second airline. The above are only examples and it is not limit which user purchases a product of which company.

Referring to FIG. 2, in the case that the user A purchases a product of the first airline and in the case that the user B purchases a product of the second airline, the transaction takes place within the physical account having the account number 1234567890, and a total amount of the physical account having the account number 1234567890 is not changed.

In this solution, the transaction takes place in sub accounts in the physical account and a third-party payment platform is not required, so that the transaction is not limited by the transfer limit specified by the People's Bank of China. In addition, the transaction between internal sub accounts does not require a transaction service charge, saving expenses. Moreover, in virtual payment with this solution, it is unnecessary to connect to a bank gateway. The virtual payment only requires interaction between the B2B website of the airline and the virtual payment system. In this way, efficient request and processing are realized, improving user experience.

With the virtual payment method according to this embodiment, flight ticket reservation information is acquired, and an account for sending the flight ticket reservation information is determined based on the flight ticket reservation information. It is determined that a payment mode for the flight ticket reservation information is virtual payment, and a virtual account for the account is determined. The virtual account for the account is set as a first virtual account, and the first virtual account is associated with a physical account. A virtual payment password of the first virtual account is acquired to perform virtual payment. A virtual currency with an amount equal to the amount of consumption in the flight ticket reservation information is deducted from the balance of the virtual currency in the first virtual account according to the virtual payment. The virtual currency with the amount equal to the amount of consumption in the flight ticket reservation information is added to a virtual account for the airline in the flight ticket reservation information. The virtual account for the airline in the flight ticket reservation information is set as a second virtual account, and the second virtual account is associated with the physical account. In the present disclosure, the first virtual account is associated with the physical account, and the second virtual account is associated with the physical account. That is, the virtual accounts for different accounts are associated with the physical account. The payment for the flight ticket reservation information through the virtual payment is actually an exchange of virtual currency between different virtual accounts associated with the same physical account. In this process, balances in the virtual accounts exchanging virtual currency with each other change, while a total amount of the physical account associated with the different virtual accounts remains unchanged. That is, an actual monetary amount in the physical account does not change, so that the payment is not limited by the implementation measures of the people's bank of China. The third-party trading platform is not required. The payment for consumption amount is directly realized through multiple virtual accounts under one physical account in a platform of the airline. The balances of different virtual accounts under the same physical account are changed without a daily transaction limit and an annual transaction limit.

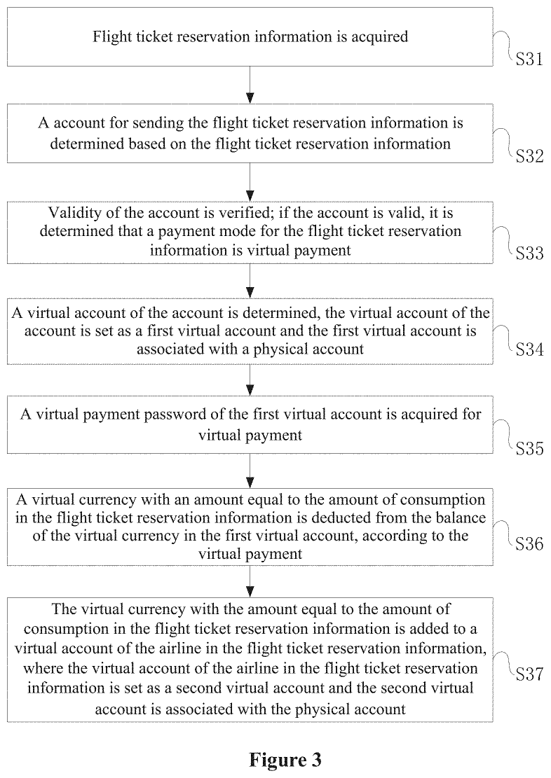

A virtual payment method is provided according to an embodiment of the present disclosure. A flowchart of the virtual payment method is as shown in FIG. 3. The method includes the following steps S31 to S37.

In step S31, flight ticket reservation information is acquired.

In step S32, an account for sending the flight ticket reservation information is determined based on the flight ticket reservation information.

In step S33, validity of the account is verified; if the account is valid, it is determined that a payment mode for the flight ticket reservation information is virtual payment.

In step S34, a virtual account of the account is determined. The virtual account of the account is set as a first virtual account and the first virtual account is associated with a physical account.

In step S35, a virtual payment password of the first virtual account is acquired for virtual payment.

In step S36, a virtual currency with an amount equal to the amount of consumption in the flight ticket reservation information is deducted from the balance of the virtual currency in the first virtual account, according to the virtual payment.

In step S37, the virtual currency with the amount equal to the amount of consumption in the flight ticket reservation information is added to a virtual account of the airline in the flight ticket reservation information, where the virtual account of the airline in the flight ticket reservation information is set as a second virtual account and the second virtual account is associated with the physical account.

The user sends the flight ticket reservation information through the account. The virtual payment system receives the flight ticket reservation information, determines the account which sends the flight ticket reservation information, and then verifies the validity of the account.

Verifying the validity of the account may include: verifying whether relevant information in the account is expired, or whether the flight ticket reservation information sent by the account is valid, or whether there is virtual currency in the virtual account corresponding to the account, or whether the virtual currency in the virtual account corresponding to the account is enough to pay the amount of consumption in the flight ticket reservation information.

No matter which aspect of the validity of the account is verified, it is to ensure that the flight ticket reservation information is paid smoothly and that the user takes the reserved flight normally.

In addition, the step of querying the balance of the virtual currency in the virtual account may be performed when the validity of the account is verified or performed separately. That is, the account of the user may query the balance of the virtual currency of the virtual account through the virtual payment system to determine the amount of the balance of the virtual currency of the virtual account.

For each user account, the user account is allowed to query a balance of a virtual currency in a virtual account corresponding to the user account and is not allowed to query a balance of a virtual currency in a virtual account corresponding to other user accounts, ensuring security of information in the user accounts.

After the user logs in to the account and before other operations are performed, the balance of the virtual currency in the virtual account may be queried directly through the virtual payment system. In addition, when reserving a flight ticket, the user may input the flight ticket reservation information in the user account, and queries the balance of the virtual currency in the virtual account through the virtual payment system before the flight ticket reservation information is sent to the virtual payment system.

Alternatively, the virtual payment system determines the amount of consumption in the flight ticket reservation information. If the balance of the virtual currency in the first virtual account is greater than the amount of consumption in the flight ticket reservation information, a virtual currency with an amount equal to the amount of consumption in the flight ticket reservation information is deducted from the balance of the virtual currency in the first virtual account.

That is, in the virtual payment, the balance of the virtual currency in the first virtual account is determined first. Payment is performed only in a case that the balance of the virtual currency in the first virtual account is greater than the amount of consumption in the flight ticket reservation information. When the balance of the virtual currency in the first virtual account is less than the amount of consumption in the flight ticket reservation information, the payment cannot be completed. Therefore, in this case, the payment is stopped, and a dialog box displaying that please recharging virtual currency for the first virtual account may be outputted, so that the user recharges the first virtual account through the dialog box, and thus the virtual payment is completed smoothly.

Further, the virtual payment method further includes: applying for a physical account. After the application is approved, multiple virtual accounts are registered based on the physical account. The multiple virtual accounts belong to different accounts respectively, and the virtual accounts for different accounts are associated with the physical account.

The association between the physical account and the virtual accounts may be realized in different manners. For example, the physical account may be first applied for, and then multiple virtual accounts respectively belonging to different accounts are directly registered in the physical account, thereby realizing the association between the virtual accounts respectively belonging to different accounts and the physical account.

Alternatively, the virtual accounts are first registered, and then the physical account is applied for. The association between the virtual accounts and the physical account is established after the existed virtual accounts and the existed physical account, so that the multiple virtual accounts respectively belonging to different accounts serve as sub accounts of the same physical account.

Alternatively, the physical account is applied for while the virtual accounts are registered. Then, the association between the virtual accounts and the physical account is established, so that the multiple virtual accounts respectively belonging to different accounts serve as sub accounts of the physical account.

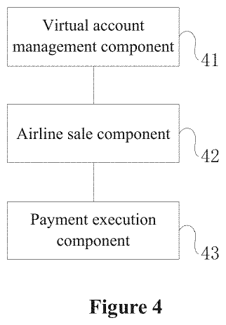

The solution may be performed by a virtual payment device. A schematic structural diagram of the virtual payment device is as shown in FIG. 4. The virtual payment device includes: a virtual account management component 41, an airline sale component 42 and a payment execution component 43.

The virtual account management component is configured to manage virtual account information, such as subject information of accounts of airlines and users, balance information of virtual currency under the accounts, and virtual currency transaction details; manage physical account information, support registration of a physical account in a bank, and bind related transaction entities, such as virtual accounts for airlines or users.

The airline sale component is configured to receive the flight ticket reservation information from a user, process and analyze a payment mode in the flight ticket reservation information, and send payment information in the virtual payment mode to the payment execution component. Payment request information includes information of a virtual account for an airline, information of a virtual account for a user, that is, order consumption amount, and the like.

The payment execution component is configured to process a business of paying virtual currency in a transaction initiated by the user at a B2B site of the airline. First, a balance of virtual currency in the virtual account management component of the account sending the flight ticket reservation information is acquired. Then, whether the transaction is established is determined according to the flight ticket reservation information. If the transaction is established, a virtual payment process is performed and a result is fed back to a terminal of the user.

With the virtual payment method according to this embodiment, flight ticket reservation information is acquired, and an account for sending the flight ticket reservation information is determined based on the flight ticket reservation information. It is determined that a payment mode for the flight ticket reservation information is virtual payment, and a virtual account for the account is determined. The virtual account for the account is set as a first virtual account, and the first virtual account is associated with a physical account. A virtual payment password of the first virtual account is acquired to perform virtual payment. A virtual currency with an amount equal to the amount of consumption in the flight ticket reservation information is deducted from the balance of the virtual currency in the first virtual account according to the virtual payment. The virtual currency with the amount equal to the amount of consumption in the flight ticket reservation information is added to a virtual account for the airline in the flight ticket reservation information. The virtual account for the airline in the flight ticket reservation information is set as a second virtual account, and the second virtual account is associated with the physical account. In the present disclosure, the first virtual account is associated with the physical account, and the second virtual account is associated with the physical account. That is, the virtual accounts for different accounts are associated with the physical account. The payment for the flight ticket reservation information through the virtual payment is actually an exchange of virtual currency between different virtual accounts associated with the same physical account. In this process, balances in the virtual accounts exchanging virtual currency with each other change, while a total amount of the physical account associated with the different virtual accounts remains unchanged. That is, an actual monetary amount in the physical account does not change, so that the payment is not limited by the implementation measures of the people's bank of China. The third-party trading platform is not required. The payment for consumption amount is directly realized through multiple virtual accounts under one physical account in a platform of the airline. The balances of different virtual accounts under the same physical account are changed without a daily transaction limit and an annual transaction limit.

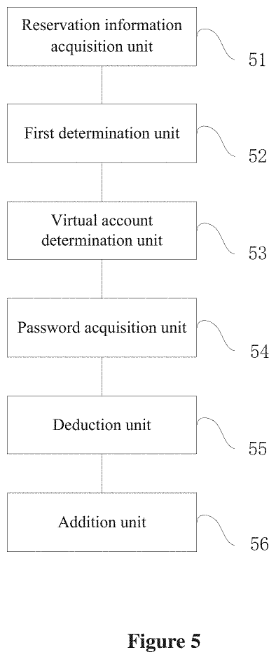

A virtual payment system is provided according to an embodiment of the present disclosure. A schematic structural diagram of the virtual payment system is as show in FIG. 5.

The virtual payment system includes a reservation information acquisition unit 51, a first determination unit 52, a virtual account determination unit 53, a password acquisition unit 54, a deduction unit 55, and an addition unit 56.

The reservation information acquisition unit 51 is configured to acquire flight ticket reservation information.

The first determination unit 52 is configured to determine an account for sending the flight ticket reservation information based on the flight ticket reservation information, and determine that a payment mode for the flight ticket reservation information is virtual payment.

The virtual account determination unit 53 is configured to determine a virtual account of the account and set the virtual account of the account as a first virtual account associated with a physical account.

The password acquisition unit 54 is configured to acquire a virtual payment password of the first virtual account for virtual payment.

The deduction unit 55 is configured to deduct a virtual currency with an amount equal to amount of consumption in the flight ticket reservation information from a balance of virtual currency in the first virtual, account according to the virtual payment.

The addition unit 56 is configured to add the virtual currency with the amount equal to the amount of consumption in the flight ticket reservation information to a virtual account of the airline in the flight ticket reservation information. The virtual account of the airline in the flight ticket reservation information is set as a second virtual account and the second virtual account is associated with the physical account.

A user logs in to an account of an airline website, and then determines the flight ticket reservation information on the website, so that a virtual payment system can receive the flight ticket reservation information determined by the user. The flight ticket reservation information includes relevant information on a reserved flight ticket, the consumption amount, an account reserving the flight ticket, time for reserving the flight ticket and the like.

After determining the account sending the flight ticket reservation information, the virtual payment system is required to determine a payment mode for the flight ticket reservation information. The virtual payment system sends inquiry information for the payment mode. That is, the virtual payment system sends the inquiry information to the account of the user to inquire which payment mode is used by the account of the user for virtual payment.

The payment mode includes internet banking payment, payment through a third-party payment platform, and virtual payment.

The user feeds back the payment mode through the account. If the user feeds back the virtual payment, the virtual payment system determines that the payment mode is the virtual payment.

After the account of the user is determined, it is required to further determine a virtual account corresponding to the account of the user. Generally, each account corresponds to one virtual account. However, in some cases, one account corresponds to multiple virtual accounts.

For ease of expression, the virtual account corresponding to the account is set as the first virtual account, and the first virtual account is associated with a physical account.

The physical account is a real bank account, for example, an account having an account number 6228 8888 8888 8888 in Bank of China or an account having an account number 6228 4888 8888 8888 888 in Agricultural Bank of China.

The virtual account is under a physical account and belongs the physical account. The virtual account is a sub account having an account number with a suffix at the bank level, that is, the virtual account is a sub account of the physical account. For example, a physical account in a bank has an account number 1234567890. A first virtual account may have an account number 1234567890-0001, and a second virtual account may have an account number 1234567890-0002.

A physical account may include multiple virtual accounts, that is, multiple sub accounts. Different virtual accounts may belong to different user accounts. For example, a first virtual account belongs to a first user account, a second virtual account belongs to a second user account, and an n-th virtual account belongs to an account of an airline.

Since a physical account includes multiple virtual accounts, each virtual account usually has a certain amount of virtual currency. If a user desires to perform virtual transaction, the user is required to register a virtual account under the physical account. After registering the virtual account, the user may recharge the virtual account through a mobile terminal or in an offline mode, so that there is virtual currency in the virtual account. After the virtual account is recharged, virtual currency with the same amount as the recharged virtual currency is added to the physical account. Alternatively, when virtual payment is required, the virtual account is recharged through a mobile terminal or in an offline mode, to make the virtual account have virtual currency, such that the virtual payment can be performed.

For example, the first virtual account is recharged with 1000 yuan. Since the first virtual account is associated with the physical account, the physical account associated with the first virtual account is also recharged with 1000 yuan.

Since there are multiple virtual accounts under one physical account and the multiple virtual accounts belong to different user accounts, recharging the first virtual account does not have any effect on other virtual accounts and the physical account adds the recharged amount. In addition, recharging other virtual accounts does not have any effect on the first virtual account, and the physical account adds the recharged amount.

The physical account in this embodiment may be a physical account of an airline. The virtual account associated with the physical account may be a virtual account for a user account that have transacted with the airline, or a virtual account for a user who will transact with the airline. Multiple virtual accounts under one physical account may belong to different user accounts. Apparently, the multiple virtual accounts associated with the physical account is required to include at least one virtual account belong to the airline which is used to perform virtual currency transactions with the virtual account for other user accounts under the physical account.

Further, if other payment mode, rather than the virtual payment, is used, for example, if payment is performed on a third-party payment platform such as Alipay, the solution disclosed in this embodiment is not applied and an original payment mode is used. However, there is a payment limit in the original payment mode. In addition, the third-party payment platform may earn handling fees.

When the payment is determined to be performed in the virtual payment mode, the virtual payment system sends an interface to a terminal in which the user account is logged in. This interface is used for the user to enter the payment password. After the user enters the payment password, the virtual payment system acquires the payment password and verifies validity of the payment password. If the payment password is valid, the following steps for virtual payment are performed. If the payment password is invalid, a prompt window which displays that the payment password is wrong is sent to the terminal with the user account.

After it is determined that the payment password is valid, the virtual payment is continued. In the process of virtual payment, the virtual currency with the amount equal to the amount of consumption in the flight ticket reservation information is deducted from the balance of the virtual currency in the virtual account corresponding to the account. In addition, the virtual currency with the amount equal to the amount of consumption is added to the virtual account for the airline in the flight ticket reservation information.

That is, the amount of consumption in the flight ticket reservation information is determined first. Then, the virtual account for the airline in the flight ticket reservation information, that is, the second virtual account, is determined. A virtual currency with an amount equal to the amount of consumption is transferred from the first virtual account to the second virtual account. In other words, the virtual currency with the amount equal to the amount of consumption is deducted from the first virtual account, and the virtual currency with the amount equal to the amount of consumption is added to the second virtual account. In this way, the virtual payment is completed.

In the above process of virtual payment, both the first virtual account and the second virtual account are associated with the same physical account, which are sub accounts of the physical account. In the transfer process of virtual currency from the first sub account to the second sub account, the total amount of the physical account is not changed. Therefore, the amount of a real bank account is not changed. A part of the amount of the real account is transferred from a sub account to another sub account, which is account management inside the real account and does not increase or decrease the amount of the real account. Therefore, the transfer of virtual currency between sub accounts in the real account is not limited by the amount of bank transfer.

FIG. 2 shows a physical account in a bank. As shown in FIG. 2, the physical account has an account number 1234567890. Virtual accounts associated with the physical account include: a virtual account having an account number 1234567890-0001 for a user A, a virtual account having an account number 1234567890-0002 for a user B, a virtual account having an account number 1234567890-0011 for a first airline, and a virtual account having an account number 1234567890-0012 for a second airline. The above four virtual accounts are associated with the physical account and are sub accounts of the physical account.

When the user A purchases a flight of the first airline, the user A transfers a virtual currency with the amount of consumption corresponding to the flight from the virtual account for the user A to the virtual account for the first airline. When the user B purchases a flight of the first airline, the user B transfers a virtual currency with the amount of consumption corresponding to the flight from the virtual account for the user B to the virtual account for the first airline. In another embodiment, the user A and the user B may purchase a flight of the second airline. The above are only examples and it is not limit which user purchases a product of which company.

Referring to FIG. 2, in the case that the user A purchases a product of the first airline and in the case that the user B purchases a product of the second airline, the transaction takes place within the physical account having the account number 1234567890, and a total amount of the physical account having the account number 1234567890 is not changed.

In this solution, the transaction takes place in sub accounts in the physical account and a third-party payment platform is not required, so that the transaction is not limited by the transfer limit specified by the People's Bank of China. In addition, the transaction between internal sub accounts does not require a transaction service charge, saving expenses. Moreover, in virtual payment with this solution, it is unnecessary to connect to a bank gateway. The virtual payment only requires interaction between the B2B website of the airline and the virtual payment system. In this way, efficient request and processing are realized, improving user experience.

In an embodiment, the first determination unit 52 is configured to determine the account for sending the flight ticket reservation information, based on the flight ticket reservation information; verify validity of the user account; and determine that a payment mode for the flight ticket reservation information is virtual payment, if the user account is valid.

The user sends the flight ticket reservation information through the account. The virtual payment system receives the flight ticket reservation information, determines the account for sending the flight ticket reservation information, and then verifies the validity of the account.

Verifying the validity of the account may include: verifying whether relevant information in the account is expired, or whether the flight ticket reservation information sent by the account is valid, or whether there is virtual currency in the virtual account corresponding to the account, or whether the virtual currency in the virtual account corresponding to the account is enough to pay the amount of consumption in the flight ticket reservation information.

No matter which aspect of the validity of the account is verified, it is to ensure that the flight ticket reservation information is paid smoothly and that the user takes the reserved flight normally.

In addition, the step of querying the balance of the virtual currency in the virtual account may be performed when the validity of the account is verified or performed separately. That is, the account of the user may query the balance of the virtual currency of the virtual account through the virtual payment system to determine the amount of the balance of the virtual currency of the virtual account.

For each user account, the user account is allowed to query a balance of a virtual currency in a virtual account corresponding to the user account and is not allowed to query a balance of a virtual currency in a virtual account corresponding to other user accounts, ensuring security of information in the user accounts.

After the user logs in to the account and before other operations are performed, the balance of the virtual currency in the virtual account may be queried directly through the virtual payment system. In addition, when reserving a flight ticket, the user may input the flight ticket reservation information in the user account, and queries the balance of the virtual currency in the virtual account through the virtual payment system before the flight ticket reservation information is sent to the virtual payment system.

Alternatively, the virtual payment system determines the amount of consumption in the flight ticket reservation information. If the balance of the virtual currency in the first virtual account is greater than the amount of consumption in the flight ticket reservation information, a virtual currency with an amount, equal to the amount of consumption in the flight ticket reservation information is deducted from the balance of the virtual currency in the first virtual account.

That is, in the virtual payment, the balance of the virtual currency in the first virtual account is determined first. Payment is performed only in a case that the balance of the virtual currency in the first virtual account is greater than the amount of consumption in the flight ticket reservation information. When the balance of the virtual currency in the first virtual account is less than the amount of consumption in the flight ticket reservation information, the payment cannot be completed. Therefore, in this case, the payment is stopped and a dialog box displaying that please recharging virtual currency for the first virtual account may be outputted, so that the user recharges the first virtual account through the dialog box, and thus the virtual payment is completed smoothly.

The virtual payment system according to the embodiment further includes: an application unit configured to apply for a physical account, and register multiple virtual accounts based on the physical account after the application is approved. The multiple virtual accounts belong to different accounts respectively, and the virtual accounts for different accounts are associated with the physical account.

The association between the physical account and the virtual accounts may be realized in different manners. For example, the physical account may be first applied for, and then multiple virtual accounts respectively belonging to different accounts are directly registered in the physical account, thereby realizing the association between the virtual accounts respectively belonging to different accounts and the physical account.

Alternatively, the virtual accounts are first registered, and then the physical account is applied for. The association between the virtual accounts and the physical account is established after the existed virtual accounts and the existed physical account, so that the multiple virtual accounts respectively belonging to different accounts serve as sub accounts of the same physical account.

Alternatively, the physical account is applied for while the virtual accounts are registered. Then, the association between the virtual accounts and the physical account is established, so that the multiple virtual accounts respectively belonging to different accounts serve as sub accounts of the physical account.

The solution may be performed by a virtual payment device. A schematic structural diagram of the virtual payment device is as shown in FIG. 4. The virtual payment device includes: a virtual account management component 41, an airline sale component 42 and a payment execution component 43.

The virtual account management component is configured to manage virtual account information, such as subject information of accounts of airlines and users, balance information of virtual currency under the accounts, and virtual currency transaction details; manage physical account information, support registration of a physical account in a bank, and bind related transaction entities, such as virtual accounts for airlines or users.

The airline sale component is configured to receive the flight ticket reservation information from a user, process and analyze a payment mode in the flight ticket reservation information, and send payment information in the virtual payment mode to the payment execution component. Payment request information includes information of a virtual account for an airline, information of a virtual account for a user, that is, order consumption amount, and the like.

The payment execution component is configured to process a business of paying virtual currency in a transaction initiated by the user at a B2B site of the airline. First, a balance of virtual currency in the virtual account management component of the account sending the flight ticket reservation information is acquired. Then, whether the transaction is established is determined according to the flight ticket reservation information. If the transaction is established, a virtual payment process is performed and a result is fed back to a terminal of the user.

With the virtual payment system according to this embodiment, flight ticket reservation information is acquired, and an account for sending the flight ticket reservation information is determined based on the flight ticket reservation information. It is determined that a payment mode for the flight ticket reservation information is virtual payment, and a virtual account for the account is determined. The virtual account for the account is set as a first virtual account, and the first virtual account is associated with a physical account. A virtual payment password of the first virtual account is acquired to perform virtual payment. A virtual currency with an amount equal to the amount of consumption in the flight ticket reservation information is deducted from the balance of the virtual currency in the first virtual account according to the virtual payment. The virtual currency with the amount equal to the amount of consumption in the flight ticket reservation information is added to a virtual account for the airline in the flight ticket reservation information. The virtual account for the airline in the flight ticket reservation information is set as a second virtual account, and the second virtual account is associated with the physical account. In the present disclosure, the first virtual account is associated with the physical account, and the second virtual account is associated with the physical account. That is, the virtual accounts for different accounts are associated with the physical account. The payment for the flight ticket reservation information through the virtual payment is actually an exchange of virtual currency between different virtual accounts associated with the same physical account. In this process, balances in the virtual accounts exchanging virtual currency with each other change, while a total amount of the physical account associated with the different virtual accounts remains unchanged. That is, an actual monetary amount in the physical account does not change, so that the payment is not limited by the implementation measures of the people's bank of China. The third-party trading platform is not required. The payment for consumption amount is directly realized through multiple virtual accounts under one physical account in a platform of the airline. The balances of different virtual accounts under the same physical account are changed without a daily transaction limit and an annual transaction limit.

The embodiments in this specification are described in a progressive way, each of which emphasizes the differences from others. For the same or similar parts among the embodiments, one may refer to description of other embodiments. Since the device disclosed in the embodiments basically corresponds to the method therein, the description thereof is relatively simple, and for relevant matters, one may refer to the description of the method embodiments.

It should be appreciated by those skilled in the art that, the exemplary units and algorithm steps in the embodiments described herein can be implemented as electronic hardware, a computer software, or a combination of computer software and the electronic hardware. In order to clearly illustrate the interchangeability of hardware and software, the composition and steps of each example have been described generally in terms of functions in the above description. Whether the functions being implemented in a hardware form or in a software form depends on a particular application of technical solutions and a design constraint. Skilled artisans may implement the described functions in varying ways for a particular application, but such implementation should not be interpreted as causing a departure from the scope of the present disclosure.

The method or algorithm steps described in conjunction with the embodiments disclosed in the present disclosure may be implemented by hardware, a software module executed by a processor, or a combination thereof. The software module may be placed in a random access memory (RAM), a memory, a read only memory (ROM), an electrically programmable ROM, an electrically erasable programmable ROM, a register, a hard disk, a removable disk, a CD-ROM, or any other form of storage medium known in the art.

The above descriptions of the disclosed embodiments make those skilled in the art can implement or apply the present disclosure. Various variations made to the embodiments are apparent for those skilled in the art. General principles defined herein may be applied to other embodiments without departing from the spirit or scope of the present disclosure. Therefore, the present disclosure is not limited to the embodiments described herein, but should comply with the widest scope consistent with the principles and novel features disclosed herein.

1. A virtual payment method, comprising:
acquiring flight ticket reservation information;
determining an account for sending the flight ticket reservation information based on the flight ticket reservation information, and determining that a payment mode for the flight ticket reservation information is virtual payment;
determining a virtual account of the account and setting the virtual account of the account as a first virtual account, wherein the first virtual account is associated with a physical account;
acquiring a virtual payment password of the first virtual account for the virtual payment;
deducting a virtual currency with an amount equal to amount of consumption in the flight ticket reservation information from a balance of virtual currency in the first virtual account, according to the virtual payment; and
adding the virtual currency with the amount equal to the amount of consumption in the flight ticket reservation information to a virtual account of an airline in the flight ticket reservation information, wherein the virtual account of the airline in the flight ticket reservation information is set as a second virtual account and the second virtual account is associated with the physical account.

2. The method according to claim 1, wherein the determining an account for sending the flight ticket reservation information based on the flight ticket reservation information, and determining that a payment mode for the flight ticket reservation information is virtual payment comprises:
determining the account for sending the flight ticket reservation information based on the flight ticket reservation information; and
verifying validity of the account, and determining that the payment mode for the flight ticket reservation information is virtual payment in a case that the account is valid.

3. The method according to claim 1, further comprising:
querying the balance of the virtual currency in the first virtual account to determine the balance of the virtual currency in the first virtual account.

4. The method according to claim 3, wherein the deducting a virtual currency with an amount equal to amount of consumption in the flight ticket reservation information from a balance of virtual currency in the first virtual account according to the virtual payment comprises:
determining the amount of consumption in the flight ticket reservation information; and
deducting the virtual currency with the amount equal to the amount of consumption in the flight ticket reservation information from the balance of the virtual currency in the first virtual account, in a case that the balance of the virtual currency in the first virtual account is greater than the amount of consumption in the flight ticket reservation information.

5. The method according to claim 1, further comprising:
applying for a physical account; and
registering a plurality of virtual accounts based on the applied physical account, wherein the plurality of virtual accounts belong to different accounts respectively, and the virtual accounts for different accounts are associated with the physical account.

6. A virtual payment system, comprising:
a reservation information acquisition unit configured to acquire flight ticket reservation information;
a first determination unit configured to determine an account for sending the flight ticket reservation information based on the flight ticket reservation information, and determine that a payment mode for the flight ticket reservation information is virtual payment;
a virtual account determination unit configured to determine a virtual account of the account and set the virtual account of the account as a first virtual account, wherein the first virtual account is associated with a physical account;
a password acquisition unit configured to acquire a virtual payment password of the first virtual account for virtual payment;
a deduction unit configured to deduct a virtual currency with an amount equal to amount of consumption in the flight ticket reservation information from a balance of virtual currency in the first virtual account, according to the virtual payment; and
an addition unit configured to add the virtual currency with the amount equal to the amount of consumption in the flight ticket reservation information to a virtual account of an airline in the flight ticket reservation information, wherein the virtual account of the airline in the flight ticket reservation information is set as a second virtual account and the second virtual account is associated with the physical account.

7. The system according to claim 6, wherein the first determination unit is configured to:
determine the account for sending the flight ticket reservation information based on the flight ticket reservation information; and
verify validity of the account, and determine that the payment mode for the flight ticket reservation information is virtual payment in a case that the user account is valid.

8. The system according to claim 6, further comprising:
a query unit configured to query the balance of the virtual currency in the first virtual account to determine the balance of the virtual currency in the first virtual account.

9. The system according to claim 8, wherein the deduction unit is configured to:
determine the amount of consumption in the flight ticket reservation information; and
deduct the virtual currency with the amount equal to the amount of consumption in the flight ticket reservation information from the balance of the virtual currency in the first virtual account, in a case that the balance of the virtual currency in the first virtual account is greater than the amount of consumption in the flight ticket reservation information.

10. The system according to claim 6, further comprising an application unit configured to:
apply for a physical account; and
register a plurality of virtual accounts based on the applied physical account, wherein the plurality of virtual accounts belong to different accounts respectively, and the virtual accounts for different accounts are associated with the physical account.
